(19) United States
(12) Patent Application Publication
(10) Pub. No.: US 2015/0039469 A1
(43) Pub. Date: Feb. 5, 2015

(54) CLASSIFICATION BASED ON VEHICULAR DATA RECORDS

(71) Applicant: HON HAI PRECISION INDUSTRY CO., LTD., New Taipei (TW)

(72) Inventors: YI-WEN CAI, New Taipei (TW); YUH-SHYING GAU, New Taipei (TW)

(73) Assignee: HON HAI PRECISION INDUSTRY CO., LTD., New Taipei (TW)

(21) Appl. No.: 13/954,964

(22) Filed: Jul. 30, 2013

(51) Int. Cl. G06Q 30/06

(52) U.S. Cl. CPC G06Q 30/0623
USPC 705/26.61

(57) ABSTRACT

A classification system with regard to vehicles is provided. The classification system includes computing device(s) and an application program executable in the computing device(s). The application program includes logic that maintains taxonomic scheme information associated with attribute(s) of vehicles sold through an electronic commerce network site, logic that obtains data record(s) of vehicle(s) sold through the electronic commerce network site, and logic that determines classification(s) associated with the vehicles basing upon the taxonomic scheme information and the data record(s). The disclosure further provides a classification method with regard to vehicles.

### BACKGROUND

1. Technical Field

The present disclosure relates to classification techniques, and particularly to classification techniques with regard to vehicles.

2. Description of Related Art

When selling new vehicles such as cars, basic information of vehicles such as the brand, the model, and the price are provided to customers. When selling used vehicles (or secondhand vehicles), except further providing the mileage data, third-party certifications are sometimes provided to certify the quality of the used vehicles. However, the above-mentioned basic information is usually insufficient in reflecting the physical conditions of the vehicles. In addition, the parameters of the used vehicles which obtained through the certifications are usually insufficient in determining the driving characteristics or other driver-impression related features of the used vehicles which are important in choosing a used vehicle.

Thus, there is room for improvement in the art.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic block diagram of an embodiment of a networked environment of the present disclosure.

FIG. 2 is a schematic diagram of a vehicle search page provided by the electronic commerce network site hosted on the electronic commerce server cloud in the networked environment shown in FIG. 1.

FIG. 3 is a schematic diagram of a vehicle transaction page provided by the electronic commerce network site hosted on the electronic commerce server cloud in the networked environment shown in FIG. 1.

FIG. 4 is a flowchart of an embodiment of a vehicle classification method implemented in the networked environment shown in FIG. 1.

### DETAILED DESCRIPTION

The present disclosure relates to classifying (or categorizing) vehicles or things relating to vehicles according to data records of vehicles. As used herein, the term “classification” refers to making groups of objects, for example, identifying to which of a set of categories (sub-populations) a new object or concept belongs, on the basis of a training set of data containing observations (or instances) whose category membership is known. The individual objects or concepts are analyzed into a set of quantifiable properties. These properties may variously be categorical (for example, “cars”, “buses”, “trucks” or “motorcycles”, indicating vehicle type), ordinal (for example, “large”, “medium” or “small”), or numerical (for example, a measurement of mileage). The term “attribute” of vehicles refers to various attributes about vehicles, for example, the usage of vehicles such as the driving characteristics, the performance of vehicles such as the torque, the physical parameters of vehicles such as the physical features and the mileage, the maintenance of vehicles such as the maintenance history, the sales of vehicles such as the expected retail price, or other attributes of vehicles.

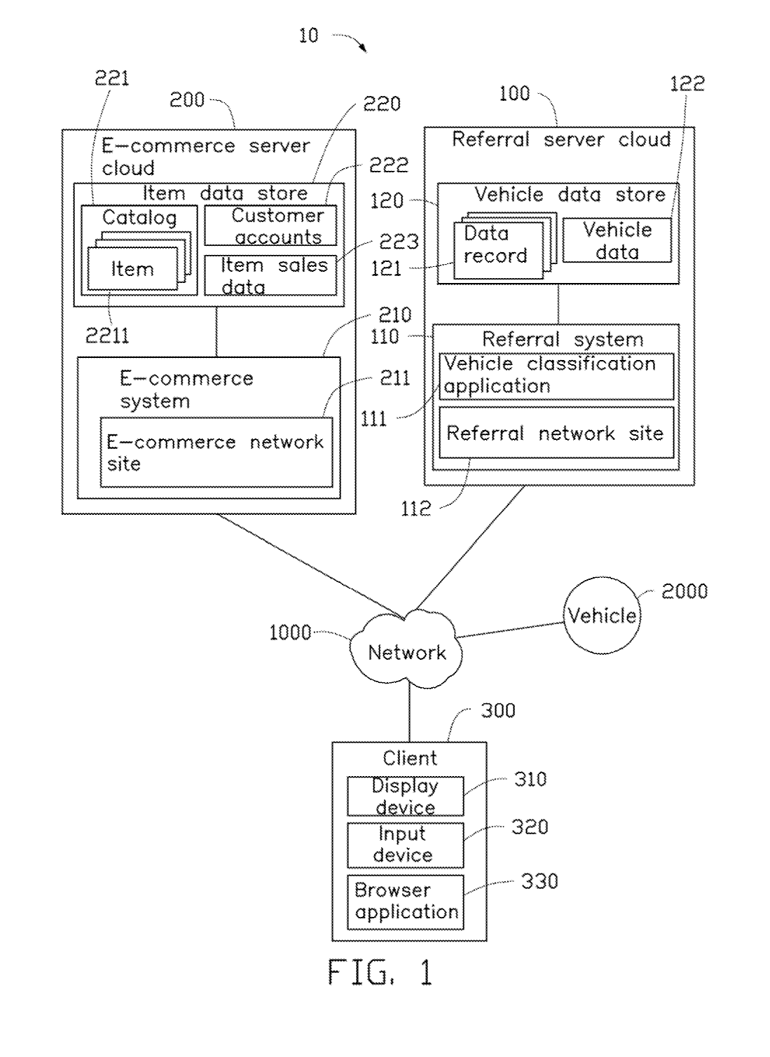

FIG. 1 is a schematic block diagram of an embodiment of a networked environment 10 of the present disclosure. In the illustrated embodiment, the networked environment 10 includes a referral server cloud 100 including a referral system 110 and a vehicle data store 120, an electronic commerce server cloud 200 including an electronic commerce system 210 and an item data store 220, and a client 300 that are coupled to a network 1000. The referral server cloud 100 and the electronic commerce server cloud 200 may each include, for example, one or more server computers. The referral server cloud 100 and the electronic commerce server cloud 200 may be located in a single installation or be dispersed. The network 1000 may include, for example, the Internet, intranets, extranets, local area networks (LANs), wide area networks (WANs), wired networks, wireless networks, or other suitable networks, or any combination of two or more such networks. The provision of referral data to an electronic commerce network site such as a shopping site hosted on the electronic commerce server cloud 200 is conducted in the networked environment 10 through a network site hosted on the referral server cloud 100, which is in association with the activities of an online merchant selling goods or services online over the network 1000.

Various data may be stored in the item data store 220 that is accessible to the electronic commerce server cloud 200. The various data stored in the item data store 220 may be accessed by the electronic commerce system 210, or possibly other systems, applications, and processes, which may be associated with, for example, the operation of the various systems, applications, or processes. In the illustrated embodiment, the item data store 220 maintains a catalog 221, customer accounts 222, and item sales data 223. The catalog 221 includes data describing a plurality of items 2211 such as goods or services on sale to customers by an online merchant. The data describing each of the items 2211 may include the item name, item images, and potentially other information of the item 2211. The items 2211 include vehicles, for example, cars, trucks, buses, motorcycles, bicycles, trains, ships, boats, aircrafts, or other mobile machines that transports passengers or cargos. In other embodiments, the items 2211 may also include vehicle-related accessories such as vehicle and driver accessories, vehicle-related services such as maintenance service, or other commodities or services.

The customer accounts 222 include data describing customers of an online merchant. The data describing each of the customers may include customer identification, delivery address, contact method, payment instruments, and potentially other data used to consummate various commercial transactions. In other embodiments, the customer accounts 222 may also include browsing histories, purchase histories, and potentially other data with regard to the behavior of each of the customer accounts 222. The item sales data 223 tracks the number of each of the items 2211 that are sold over time through the electronic commerce system 210, and potentially other information about the sales of the items 2211.

The systems executed in the electronic commerce server cloud 200 include the electronic commerce system 210. The electronic commerce system 210 includes an electronic commerce network site 211 such as a web site on the Internet that facilitates electronic commerce. The electronic commerce system 210 is configured to conduct electronic commerce to facilitate the network presence of an online merchant through the electronic commerce network site 211 for shopping and potentially other commercial purposes. Examples of such sites include “www.amazon.com”, “www.ebay.com”, and other such sites. The applications or components that make up the electronic commerce system 210 provide various functions to facilitate electronic commerce such as accessing and maintaining the catalog 221. The electronic commerce system 210 also facilitates various functions associated with the operation of the electronic commerce network site 211, for example, generating network features such as web pages or other network contents that are served up to the customer-controlled client 300 to provide for searching for the items 2211 and presenting search results for such items 2211. Such network pages may also present detailed information about the items 2211 and may facilitate the purchase of the items 2211 by, for example, providing for payment for the items 2211. Such network pages may be static or created dynamically.

The system executed in the referral server cloud 100 includes the referral system 110. The referral system 110 includes a vehicle classification application 111 and a referral network site 112. In the embodiment, the referral network site 112 provides for a classification associated with vehicles sold through the electronic commerce network site 211. The referral network site 112 may also provide for a classification associated with vehicles sold through other electronic commerce network sites, or other functions such as item recommendation, item comparison, or advertising. The referral network site 112 may provide a classification of vehicles or things relating to vehicles, for example, the driving habits of a user of a vehicle. The referral network site 112 classifies the vehicles or other things relating to the vehicles, as items 2211, sold through the electronic commerce network site 211 by providing classification information Ic (not shown) to the electronic commerce network site 211 in response to receiving a referral request Rr (not shown) from the electronic commerce network site 211 as will be described.

The vehicle classification application 111 is executed in the referral server cloud 100 in order to produce the classification information Ic. The classification information Ic may include listing(s) of a subset of all of the items 2211 stored in the catalog 221 which have already been classified. The listing(s) may include information about the classification of each of the items 2211, for example, the identification, the respective classification(s), and possibly other information.

Various data may be stored in the vehicle data store 120 that is accessible to the referral server cloud 100. The various data stored in the vehicle data store 120 may be accessed by the referral system 110, or possibly other systems, applications, and processes, which may be associated with, for example, the operation of the various systems, applications, or processes. In the illustrated embodiment, the vehicle data store 120 maintains data records 121 and vehicle data 122. The data records 121 may be embodied in the form of files or data structures such as arrays, lists, or trees. Each of the data records 121 includes record(s) of data of a vehicle 2000 which are produced according to, for example, parameter(s) of the vehicle 2000 which were produced by measuring instrument(s) such as odometer or accelerometer. The vehicle data 122 may include data that describes the vehicle 2000 including the vehicle identification, the basic information of the vehicle 2000, and potentially other data about the vehicle 2000.

The client 300 is representative of a plurality of client devices that may be coupled to the network 1000. The client 300 may include, for example, a processor-based system such as a computer system embodied in the form of a desktop computer, a laptop computer, a cell phone, a tablet computer, or other devices with like capability. In the embodiment, the client 300 includes a display device 310, an input device 320, and may also include other peripheral devices such as speaker. The display device 310 may include liquid crystal display (LCD) screen or other display devices. The input device 320 may include a keyboard, a touch panel, a mouse, a microphone, or other input device.

Executed within the client 300 are various applications including a browser application 310. The browser application 310 is configured to interact with the electronic commerce system 210 and potentially other systems or applications on the electronic commerce server cloud 200 according to an appropriate protocol such as Transmission Control Protocol/Internet Protocol (TCP/IP) or other protocol. The browser application 310 may include, for example, a web browser such as MOZILLA FIREFOX®, or other type of interface applications with like capability. The browser application 310 provides network-related functions including rendering network pages such as web pages, and may implement the execution of active portions of the network pages.

The vehicle 2000 is one representative of a plurality of vehicles that may be coupled to the network 1000. The vehicle 2000 is a mobile machine such as a car or a motorcycle which, with a network communication device, functions to access the network 1000. The network communication device may include a wireless network communication device such as a WI-FI module or a long term evolution (LTE) module. In the embodiment, the vehicle 2000 also includes measuring instrument(s), for example, odometers, accelerometers, gyroscopes, or other meters or sensors, which produce data of the vehicle 2000 or of the environment where the vehicle 2000 is located. The vehicle 2000 communicates with the referral server cloud 100 through the network 1000, such that the vehicle data store 120 can be accessed, and the data of the vehicle 2000 can be stored in the vehicle data store 120 in the form of, for example, the data records 121, and can be retrieved from the vehicle data store 120.

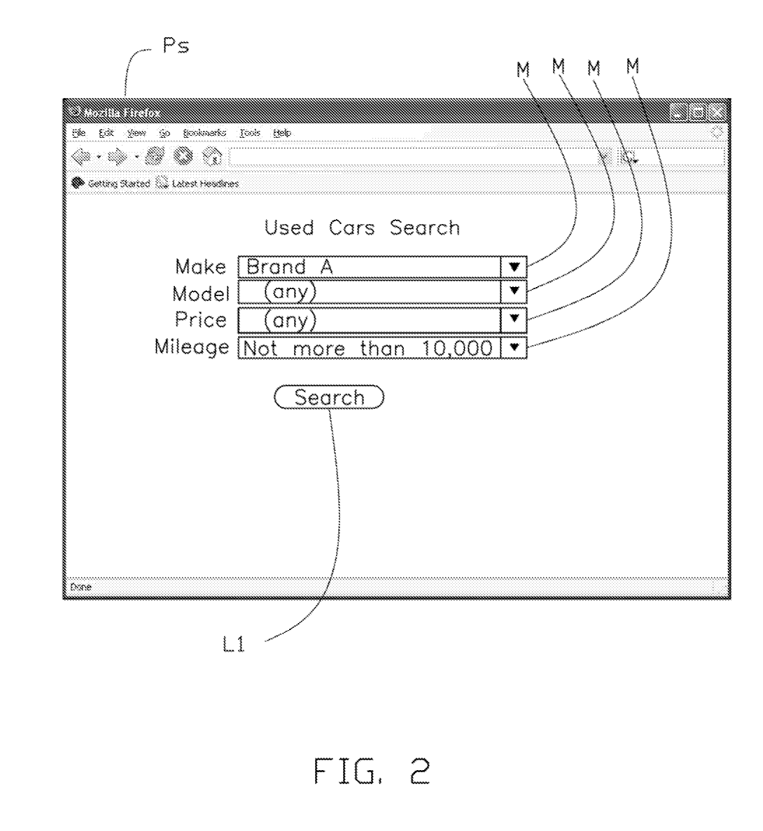

FIG. 2 is a schematic diagram of a vehicle search page Ps provided by the electronic commerce network site 211 hosted on the electronic commerce server cloud 200 in the networked environment 10 shown in FIG. 1. In the illustrated embodiment, the vehicle search page Ps facilitates the searching of used cars, which displays pull-down menus M for performing searches for the items 2211, as the vehicles sold through the electronic commerce network site 211, such that a user can specify search condition(s) through the pull-down menus M to search for the items 2211 which belong to the target classification(s). Each of the pull-down menus M is associated with a search condition Cs (not shown) such as the brand, the model, the price, or the mileages of vehicles. A link L1 is embodied in the form of a “search” button, which allows the user to search for the items 2211 corresponding to the search condition(s) Cs specified through the pull-down menus M, by clicking on the button. In other embodiments, the vehicle search page Ps may perform searches for the items 2211 through displaying other types of graphical user interfaces such as tree style tabs.

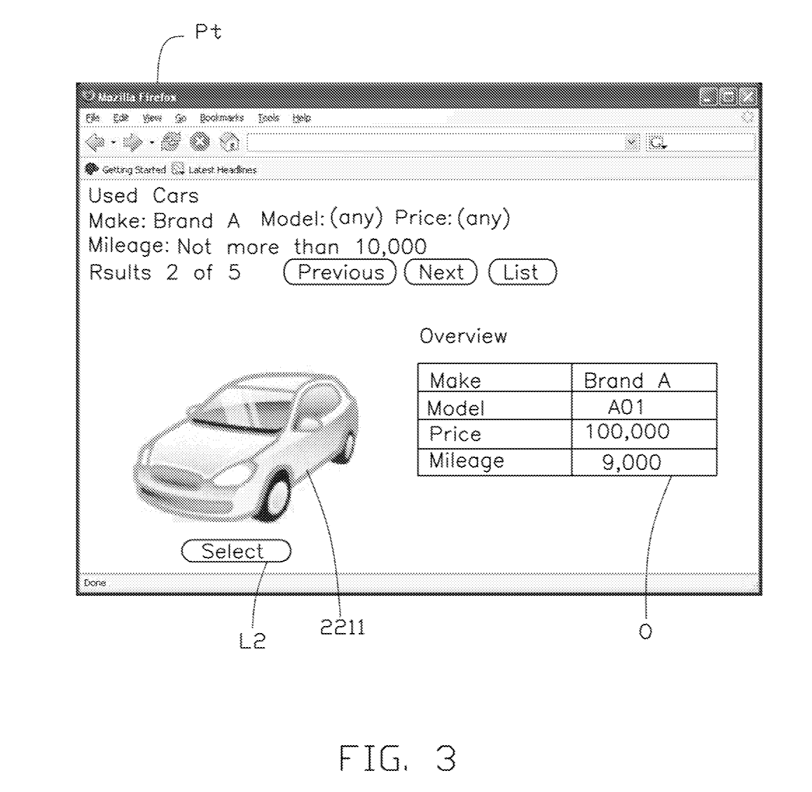

Upon manipulating the link L1, the vehicle classification application 111 produces the classification information Ic including search results corresponding to the search condition(s) Cs, and then the user is referred to a vehicle transaction page Pt (see FIG. 3) generated by the electronic commerce system 210 which includes, for example, a detailed page presenting the search results in the classification information Ic which include the items 2211 corresponding to any search condition(s) Cs, with the further ability to place such items into a shopping cart and proceed to checkout in order to purchase such item(s) 2211 or take other action. In the illustrated embodiment, in order to cause the electronic commerce system 210 to generate the vehicle transaction page Pt, the link L1 causes the browser application 330 to generate a network page request Rp (not shown) for the specific vehicle transaction page Pt including the detailed page presenting the search results. The electronic commerce network site 211 generates the referral request Rr including the search condition(s) Cs specified by the user in response to receiving the network page request Rp.

FIG. 3 is a schematic diagram of the vehicle transaction page Pt generated by the electronic commerce system 210 hosted on the electronic commerce server cloud 200 in the networked environment 10 shown in FIG. 1. In the illustrated embodiment, the vehicle transaction page Pt facilitates the sales of used cars, which displays the search results including the items 2211 corresponding to the search condition(s) Cs by presenting one of the vehicular items 2211 sold through the electronic commerce network site 211, along with an overview O of the item 2211. Associated with each of the items 2211 is a link L2 embodied in the form of a “select” button, which allows a user to pursue a purchase of an item 2211 by clicking on the button. Upon manipulating the link L2, the user specifies the particular item 2211 to purchase.

In some situations, there may be a commercial relationship established between the operator of the referral network site 112 and a merchant who operates the electronic commerce system 210. The commercial relationship can be embodied in the form of a business model implemented through the components in the networked environment 10. For example, the merchant operating the electronic commerce system 210 may pay the operator of the referral network site 112 a predefined fee for each referral (for example, the classification information Ic) received. Alternatively, the merchant and the operator of the referral network site 112 may agree that the merchant is to pay the operator a predefined percentage of the sales price for all of the items 2211 which are sold, based upon a referral received from the referral network site 112. A number of referrals may be tracked and maintained in both the electronic commerce server cloud 200 by the merchant and in the referral server cloud 100 by the operator of the referral network site 112, so that precise amounts owed based upon referrals as described above can be identified. Similarly, the number of sales based upon a referral may be maintained in the electronic commerce server cloud 200, for example, in the item sales data 223, so that appropriate amounts may be calculated to pay to the operator of the referral network site 112.

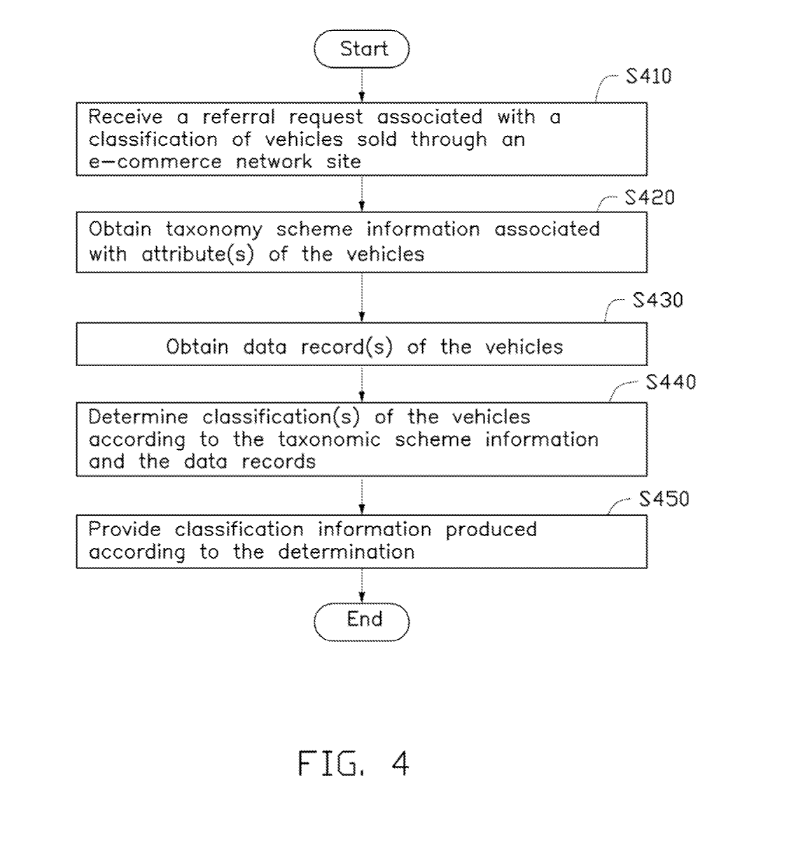

FIG. 4 is a flowchart of an embodiment of a vehicle classification method implemented in the networked environment 10 shown in FIG. 1. The classification method is executed to determine classifications for the items 2211 within the classification information Ic provided to the electronic commerce network site 211 as described above. The classification method of the present disclosure is as follows. Steps S410-S440 are implemented through instructions of the vehicle classification application 111 hosted on the referral server cloud 100. Step S450 is implemented through instructions of the referral network site 112 hosted on the referral server cloud 100. Depending on the embodiment, additional steps may be added, others removed, and the ordering of the steps may be changed.

In step S410, the referral request Rr associated with a classification of the vehicles sold through the electronic commerce network site 211 is received. In the illustrated embodiment, the referral request Rr is associated with searching for vehicles based on specified conditions, which includes the search condition(s) Cs specified by the user. The referral request Rr may also include information for differentiating the vehicles sold through the electronic commerce network site 211 from other vehicles, for example, the vehicles sold through other electronic commerce network sites. In other embodiments, the referral request Rr can be associated with other functions associated with vehicles, for example, classifying a vehicle into one or more classifications. When the referral request Rr initiates the classification of a vehicle, an identification of the vehicle may be included. In addition, the referral request Rr can be associated with a classification associated with other items sold through the electronic commerce network site 211, for example, objects such as electronic devices.

In step S420, taxonomic scheme information It (not shown) associated with attribute(s) of the vehicles is obtained. In the illustrated embodiment, the taxonomic scheme information It includes a plurality of classifications of vehicles, each of the classifications includes one or more attributive conditions. Each of the attributive conditions corresponds to one attribute of vehicles, which is a condition for classifying a vehicle into the correct classification. Each search condition Cs in the referral request Rr corresponds to one of the classifications of vehicles. Where a classification includes one attributive condition, a vehicle is classified into the classification when an attribute of the vehicle corresponds to the corresponding attributive condition. Where a classification which includes a plurality of attributive conditions, a vehicle is classified into the classification in which the relevant attributes of the vehicle correspond to each of the corresponding attributive conditions. In other embodiments, when the referral request Rr is for a classification associated with other objects such as electronic devices, taxonomic scheme information associated with attribute(s) of the objects can be obtained.

In the illustrated embodiment, a classification of vehicles may directly represent one or more attributes of vehicles. For instance, a classification in the taxonomic scheme information It which is associated with mileage may include attributive condition(s) associated with the quantity of mileage. In addition, a classification of vehicles may represent the consequences of one or more attributes of vehicles. For instance, a classification in the taxonomic scheme information It which is associated with a quantity of maneuverability may include attributive condition(s) associated with a quantity of torque and potentially a quantity of other attributes.

The attribute of vehicles can be, for example, the usage of vehicles such as the driving characteristics and the location history, the performance of vehicles such as the velocity, the acceleration, the torque, and the horsepower, the physical parameters of vehicles such as the physical features (for example, car color, electric windows, and intermittent screen wipers), the location, the mileage, the power consumption, and the expected lifetime, the maintenance of the vehicles such as the maintenance history and the maintenance costs, the sales of the vehicle such as the expected retail price, or other characteristics such as the brand and the model. Each attributive condition may include an identification of an attribute, and may also include value(s) of the attribute. The value(s) may variously be numerical (for example, an upper limit, a lower limit, or a range), ordinal (for example, “large”, “medium” or “small”), categorical (for example, “cars”, “buses”, “trucks” or “motorcycles”, indicating vehicle type), or be other type of quantifiable value.

Table 1 below shows an example of the taxonomic scheme information It. The entry of each of the classifications in the taxonomic scheme information It includes a classification identification and one or more attributive conditions. Each attributive condition includes an identification and a range of values on a normalized scale for the attributive condition. For instance, the entry of “Mileage not more than 10,000 Miles” classification has a “Mileage” attributive condition with the range of 0˜10,000 miles.

TABLE 1

| Classification | Mileage not | Attributive Condition 1 | | | | . . . |
|---|---|---|---|---|---|---|
| Identification | more than | Identi- | Mile- | Value | 0~10,000 | . . . |
| | 10,000 Miles | fication | age | Range | | |
| Classification | . . . | Attributive Condition 1 | | | | . . . |
| Identification | | Identi- | . . . | Value | . . . | . . . |
| | | fication | | Range | | |

In step S430, the data records 121 of the vehicles are obtained. In the illustrated embodiment, the data records 121 include data produced according to parameter(s) produced by measuring instrument(s). The measuring instrument(s) may be, for example, odometers, accelerometers, gyroscopes, or other meters or sensors which produce data of the vehicle 2000 or of the environment where the vehicle 2000 is located. An attribute of vehicles may directly correspond to one or more parameters of vehicles. For instance, the attribute associating with a quantity of mileage may correspond to the parameter(s) associate with mileage. In addition, an attribute of vehicles may correspond to the consequences of one or more parameters of vehicles. For instance, the attribute associating with a quantity of maneuverability may correspond to the parameter(s) associate with torque and potentially other parameter(s). Each of the data records 121 includes one category of data of one of the vehicles, for example, usage data such as driving characteristics data and location history data, performance data such as velocity data, acceleration data, torque data, and horsepower data, physical parameter data such as physical features data, location data, mileage data, power consumption data, and expected lifetime data, maintenance data such as maintenance history data and maintenance costs data, sales data such as expected retail price data, or potentially data for other characteristics such as brand data and model data.

The data in each of the data records 121 may be in a form such as current value data, historical data, or statistical data, which may include value(s) on a normalized scale for the data of the vehicle. For instance, the data record 121 associated with mileage data will have a numerical value in unit of miles. In other embodiments, when the referral request Rr includes the information for differentiating the vehicles sold through the electronic commerce network site 211 from other vehicles, the data records 121 of the vehicles can be obtained according to the information. In addition, when the referral request Rr initiates the classification of a vehicle, the data record(s) 121 of the corresponding vehicle are obtained. Furthermore, when the referral request Rr is for a classification associated with other objects such as electronic devices, data records associated with the objects can be obtained.

In step S440, classification(s) of the vehicles are determined according to the taxonomic scheme information It and the data records 121. In the illustrated embodiment, the classification(s) of the vehicles are determined by mapping the value(s) of the data record(s) 121 of each of the vehicles to the range of values of the attributive condition(s) of the classification(s) of vehicles in the taxonomic scheme information It corresponding to the search condition(s) Cs in the referral request Rr (each of the search condition(s) Cs corresponds to one of the classifications of vehicles), and the result(s) of the determination are then stored in, for example, a system memory of the referral server cloud 100 or the vehicle data store 120, for use by the vehicle classification application 111. The mapping can be performed by, for example, comparing the value(s) of the data record(s) 121 of each of the vehicles with the range of values of the attributive condition(s) of each of the classifications of vehicles in the taxonomic scheme information It corresponding to the search condition(s) Cs in the referral request Rr. The determination result(s) may include, for example, identification(s) of the vehicle(s) belong to the classification(s) specified by the search condition(s) Cs in the referral request Rr, and may also include information of the vehicle(s), for example, the attribute(s) of the vehicles which correspond to the search condition(s) Cs.

In other embodiments, classifications of things relating to vehicles can also be determined according to the taxonomic scheme information It and the data records 121. For instance, the driving habits of a user of a vehicle can be determined according to the taxonomic scheme information It and the data records 121 including driving characteristics data. In addition, when the referral request Rr initiates the classification of a vehicle, classification(s) of the vehicle are determined according to the taxonomic scheme information It and the data record(s) 121 of the vehicle. Furthermore, when the referral request Rr is for a classification associated with other objects such as electronic devices, classification(s) associated with the objects can be determined according to taxonomic scheme information and data records associated with the objects.

In step S450, the classification information Ic produced according to the determination is provided. The classification information Ic is produced according to the determination result(s) obtained through the determination and possibly other information corresponding to the determination result(s). In the illustrated embodiment, the classification information Ic includes a listing of the identification(s) of the vehicle(s) in the determination result(s) which correspond to the search condition(s) Cs in the referral request Rr and information of the vehicles in the listing, for example, the attribute(s) of the vehicles corresponding to the search condition(s) Cs. The classification information Ic is provided to the electronic commerce network site 211 through the referral network site 112. In other embodiments, when the referral request Rr initiates the classification of a vehicle, the classification information Ic can include a listing of the classification(s) to which the vehicle belongs.

The vehicle classification method is capable of classifying vehicles or things relating to vehicles according to data records of the vehicles. Since the data records storing parameters produced by measuring instruments disposed on the vehicles are used, the classification is capable of reflecting the instant physical condition of the vehicles. This is especially suitable for classifying used vehicles or test vehicles. The classification method can be embodied in the form of a network service which provided by, for example, the operator of a server cloud with a data store maintaining data records of vehicles. The results of classification can be utilized in various domains, for example, item search, item classification, item recommendation, item comparison, advertising, or statistical analysis.

While the disclosure has been described by way of example and in terms of a preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A method, comprising:
obtaining taxonomic scheme information associated with one or more attributes of vehicles;
obtaining one or more data records associated with a vehicle; and
determining one or more classifications associated with the vehicle based upon the taxonomic scheme information and the one or more data records.

2. The method of claim 1, wherein the step of obtaining the taxonomic scheme information comprises:
obtaining the taxonomic scheme information including a plurality of classifications of vehicles, each of the classifications being associated with one or more attributes of vehicles, each of the one or more attributes being associated with one or more values on a corresponding normalized scale for the respective attribute of vehicles; and
the step of obtaining the one or more data records comprises:
obtaining the one or more data records, each of the one or more data records being associated with one or more values on a corresponding normalized scale for data of a vehicle.

3. The method of claim 2, wherein the step of obtaining the taxonomic scheme information comprises:
obtaining the taxonomic scheme information including a plurality of classifications of vehicles, each of the classifications including one or more attributes of vehicles, each of the one or more attributes including one or more values on a corresponding normalized scale for the respective attribute of vehicles;
the step of obtaining the one or more data records comprises:
obtaining the one or more data records, each of the one or more data records including one or more values on a corresponding normalized scale for data of a vehicle; and
the step of determining the one or more classifications associated with the vehicle comprises:
determining the one or more classifications associated with the vehicle by mapping the one or more values of the one or more data records of the vehicle to the one or more values of the one or more attributes.

4. The method of claim 1, wherein the step of obtaining the taxonomic scheme information comprises:
obtaining the taxonomic scheme information associated with one or more attributes of vehicles sold through an electronic commerce network site; and
the step of obtaining the one or more data records comprises:
obtaining the one or more data records associated with a vehicle sold through the electronic commerce network site.

5. The method of claim 4, wherein the step of obtaining the one or more data records comprises:
obtaining data records of the vehicles sold through the electronic commerce network site, each of the data records being associated with data of one of the vehicles;
the step of determining the one or more classifications associated with the vehicle comprises:
determining the one or more classifications associated with the vehicles based upon the taxonomic scheme information and the data records; and
the method further comprises:
providing classification information produced based upon the determination, the classification information including an identification of the vehicle belonging to one or more specified classifications.

6. The method of claim 5, wherein the step of providing the classification information comprises:
providing, using a referral network site, the classification information produced based upon the determination, the classification information including an identification of the vehicle belonging to one or more specified classifications.

7. The method of claim 1, wherein the method further comprises:
providing classification information produced based upon the determination, the classification information including an identification of the vehicle belonging to one or more specified classifications.

8. The method of claim 1, wherein the method further comprises:
providing classification information produced based upon the determination, the classification information including at least one of the one or more classifications the vehicle belonging to.

9. The method of claim 1, wherein the one or more attributes of the vehicle associate with at least one of the usage, the performance, the physical parameter, the maintenance, and the sales of the vehicle.

10. The method of claim 1, wherein the one or more data records are produced based on one or more parameters produced by one or more measuring instruments.

11. A system, comprising:
at least one computing device; and
an application program executable by the at least one computing device, the application program comprising:
logic that maintains taxonomic scheme information associated with one or more attributes of vehicles sold through an electronic commerce network site;
logic that obtains one or more data records of a vehicle sold through the electronic commerce network site; and
logic that determines one or more classifications associated with the vehicle basing upon the taxonomic scheme information and the one or more data records.

12. The system of claim 11, wherein the taxonomic scheme information includes a plurality of classifications of vehicles, each of the classifications includes one or more attributes of vehicles, each of the one or more attributes includes one or more values on a corresponding normalized scale for the respective attribute of vehicles; each of the one or more data records includes one or more values on a corresponding normalized scale for data of a vehicle.

13. The system of claim 12, wherein the one or more classifications associated with the vehicle is determined by mapping the one or more values of the one or more data records of the vehicle to the one or more values of the one or more attributes.

14. The system of claim 11, wherein data records of the vehicles sold through the electronic commerce network site are obtained, each of the data records associates with data of one of the vehicles; the application program further comprises:
logic that provides classification information produced based upon the determination, the classification information includes an identification of the vehicle belonging to one or more specified classifications.

15. The system of claim 14, wherein the classification information is provided by a referral network site to the electronic commerce network site.

16. The system of claim 11, wherein the application program further comprises:
logic that provides classification information produced based upon the determination, the classification information includes an identification of the vehicle belonging to one or more specified classifications.

17. The system of claim 11, wherein the application program further comprises:
logic that provides classification information produced based upon the determination, the classification information includes at least one of the one or more classifications the vehicle belonging to.

18. The system of claim 11, wherein the one or more attributes of the vehicle associate with at least one of the usage, the performance, the physical parameter, the maintenance, and the sales of the vehicle.

19. The system of claim 11, wherein the one or more data records are produced based on one or more parameters produced by one or more measuring instruments.

20. A non-transitory computer-readable medium embodying a program executable in a computing device, the program comprising:
code that maintains taxonomic scheme information associated with one or more attributes of vehicles sold through an electronic commerce network site;
code that obtains one or more data records of a vehicle sold through the electronic commerce network site; and
code that determines one or more classifications associated with the vehicle basing upon the taxonomic scheme information and the one or more data records.
